(19) United States
(12) Patent Application Publication
(10) Pub. No.: US 2019/0308522 A1
(43) Pub. Date: Oct. 10, 2019

(54) METHOD AND SYSTEM FOR MANAGING A RECHARGEABLE ELECTRIC OR HYBRID VEHICLE

(71) Applicant: BLUECAR, Puteaux Cedex (FR)

(72) Inventors: Christophe BARDOT, Montigny-le-Bretonneux (FR); Alain ROCHAIS, Plaisir (FR); Guillaume LESNIK, Elancourt (FR); Laurent PERRIER, Attiches (FR)

(21) Appl. No.: 16/465,958

(22) PCT Filed: Dec. 19, 2017
(86) PCT No.: PCT/EP2017/083493

§ 371 Date: May 31, 2019

(30) Foreign Application Priority Data
Dec. 21, 2016 (FR) 1662971

(51) Int. Cl. B60L 58/27; B60K 6/28; H01M 10/613; H01M 10/615; H01M 10/625; H01M 10/44; B60L 58/20; B60L 53/16; B60L 58/13; B60L 58/26

(52) U.S. Cl. CPC B60L 58/27; B60K 6/28; H01M 10/613; H01M 10/615; B60L 58/26; H01M 10/443; B60L 58/20; B60L 53/16; B60L 58/13; H01M 10/625

(57) ABSTRACT

A method for managing an electric or hybrid vehicle including at least one rechargeable electrical energy storage module, each storage module being arranged in order to:
provide a high-voltage electrical supply signal for the drive of the vehicle, and
be maintained at a temperature, called operating temperature, by a heating apparatus;
   said method including, before a prolonged period of non-use of the vehicle, a phase, called winterizing phase, including a step of cooling each storage module in order to reach a predetermined temperature, lower than the operating temperature.

A system and a vehicle implementing such a method are also provided.

The present invention relates to a method for managing a rechargeable electric or hybrid vehicle, in particular during a prolonged period of non-use of said vehicle. It also relates to a system and a vehicle implementing such a method.

The field of the invention is the field of electric or hybrid vehicles equipped with rechargeable batteries, and in particular the field of managing these batteries.

### PRIOR ART

Rechargeable hybrid and electric vehicles are equipped with electrical energy storage modules, for example with capacitive technology, which supply the power train of the vehicle. These electrical energy storage modules are charged either by an electric generator within the vehicle or using external charging terminals that are themselves linked to the power distribution grid, for example.

For example, electrical energy storage modules of the LMP® (Lithium-Metal-Polymer) type are known, operating at a temperature greater than ambient temperature. These modules thus need to be heated at all times. The use of storage modules at a temperature greater than ambient temperature (or “hot pack”) is also being developed for other types of electrical energy storage technology.

Now, heating the electrical energy storage modules is prejudicial to the battery life of the electric or hybrid vehicle, in particular when it is not in use. In addition, due to natural electrical discharge, or self-discharge, the electrical energy storage modules can drain completely, which can degrade them.

An aim of the present invention is to overcome the abovementioned drawbacks.

Another aim of the invention is to propose a method and a system for managing an electric or hybrid vehicle reducing the losses of electrical energy during a prolonged period of non-use.

Yet another aim of the invention is to propose a method and a system for managing an electric or hybrid vehicle reducing the risk of deterioration of the electrical energy storage modules that can be caused by a total discharge of said modules.

### SUMMARY OF THE INVENTION

The invention proposes to achieve at least one of the abovementioned aims by a method for managing an electric or hybrid vehicle comprising at least one rechargeable electrical energy storage module, each storage module being arranged in order to:
provide a high-voltage electrical supply signal for the drive of said vehicle, and
be maintained at a temperature, called operating temperature, by a heating means, in particular a dedicated heating means;
said method comprising, before a prolonged period of non-use of said vehicle, a phase, called winterizing phase, comprising a step of cooling each storage module in order to reach a predetermined temperature, lower than said operating temperature.

The management method according to the invention thus proposes, with a prolonged period of non-use of the vehicle in view, not to maintain the rechargeable storage modules of the vehicle in a normal operational state. Thus, the modules cannot be used to supply the electric motor(s) of the vehicle, as their temperature is lower than the intended operating temperature for said modules.

As a result, during the period of non-use, the storage modules are no longer heated. This makes it possible to save energy and thus to reduce the energy losses during a period in which the vehicle will not be in use.

In addition, the fact of reducing the energy losses makes it possible to reduce the risk of deterioration of an electrical energy storage module that can be caused by a total discharge of said module. In fact, reducing the discharge of a module makes it possible to reduce the risk that this module reaches a state of total discharge. The fact of reducing the loss of charge of a module extends the period culminating in total discharge of said module, when it is not in use.

The predetermined temperature can preferably be ambient temperature, or a temperature closer to ambient temperature than the operating temperature, or even a temperature slightly greater than ambient temperature.

According to a preferred example embodiment, each electrical energy storage module can comprise one or more LMP® batteries.

In this case, the operating temperature is of the order of 70° C., and more generally comprised between 60° C. and 80° C.

In the present application, the expression “high voltage” denotes an electrical voltage greater than or equal to 60 V. According to the current standards, such a voltage is called “hazardous voltage”.

According to an example embodiment, the high-voltage signal supplied by the module(s) is a voltage signal comprised between 100 V and 650 V, preferentially of the order of 400 V or 600 V according to the applications.

Advantageously, the step of cooling one, in particular each, storage module can comprise:
turning off the means of heating said module, and
natural cooling of said storage module.

Thus, the step of cooling said module does not consume electrical energy and does not reduce the charge level of said module.

The electric or hybrid vehicle can comprise at least one low-voltage battery, supplying at least one low-voltage circuit within said vehicle.

In particular, the at least one low-voltage battery can supply all of the low-voltage components of the vehicle through one or more low-voltage circuits, such as the electronic modules of the vehicle, but also the auxiliary devices within the vehicle such as the power-assisted steering or a user interface.

In addition, said at least one low-voltage battery can be charged from a signal provided by the storage module(s) of the vehicle.

According to a particularly advantageous version of the method according to the invention, the winterizing phase can also comprise a step of turning off the low-voltage supply provided by said low-voltage battery.

In this case, turning off the supply originating from said battery can involve all the low-voltage components so that no low-voltage component is supplied by said at least one low-voltage battery.

Thus, the electrical consumption within said vehicle is minimized during the overwintering phase.

In order to do this, an electrical or electronic control unit can be provided that is configured in order to:
turn off the low-voltage supply before the period of non-use, and
restore said low-voltage supply at the end of the period of non-use.

Of course, this control unit will itself be supplied at all times, for example by said low-voltage battery or a a dedicated battery.

In particular, turning off the low-voltage supply within the vehicle can be carried out by controlling a component for turning off the electrical connection, for example a relay, linking said at least one battery to said at least one low-voltage circuit.

Such a component can be positioned as close as possible to said at least one battery and can be controlled by the control unit, itself supplied by said at least one battery.

According to an example embodiment, the disconnection component can be positioned between the low-voltage circuit or circuits on the one hand and the low-voltage battery and the control unit on the other hand, the latter being supplied by said battery.

The control unit can be a switching unit (or control box) within said vehicle.

Preferentially, the step of turning off the low-voltage supply can be carried out after the cooling step.

More particularly, the step of turning off the low-voltage supply can be carried out when each module has reached the predetermined temperature.

Thus, the vehicle is provided with a low-voltage supply during the decrease in temperature of the storage module or modules, which makes it possible to control said decrease in temperature and to ensure that it is carried out correctly for each storage module.

The winterizing phase can be initiated following a request of a user, for example through a user interface within the vehicle.

The user interface can be a touch interface, for example a control on the touch screen of the dashboard, or a physical interface that can be actuated mechanically, for example using a key or a push-button etc.

The winterizing phase can also be initiated automatically when a predetermined parameter, relating to a storage module, reaches a predetermined threshold value.

For example, when the state of charge (SOC) reaches a value lower than or equal to 1%, the winterizing phase can be initiated in order to avoid said storage module reaching total discharge, which could cause it damage.

According to a particular embodiment, the method according to the invention can comprise stopping and cancelling the winterizing phase following detection, during said winterizing phase, of a high-voltage signal supplying said vehicle via an external source.

For example, when a user connects the vehicle to a supplied charging socket, then the winterizing phase can be cancelled.

Following a prolonged period of non-use of said vehicle, the method according to the invention can comprise a phase, called dewinterizing phase, comprising a step of heating each storage module in order to reach said operating temperature.

Of course, such a dewinterizing phase is only possible when the vehicle is connected to an external energy source, providing it with a supply signal making it possible firstly to heat each storage module, then optionally to recharge it.

The dewinterizing phase can preferentially comprise:
a step of heating each module by a heating signal delivered by the external source, in order to reach the operating temperature;
and optionally, a step of charging at least one module, by a charging signal, delivered by said external source.

According to another embodiment, the heating signal can have a voltage lower than the charging signal.

The heating signal can for example have a voltage comprised between 90 V and 110 V, in particular of the order of 100 V.

The charging signal can for example have a voltage comprised between 100 V and 650 V, in particular of the order of 400 V or 600 V according to the applications.

When the low-voltage supply of the vehicle has been turned off during the winterizing phase, the dewinterizing phase can comprise re-establishing the low-voltage supply by at least one low-voltage battery.

Re-establishing the low-voltage supply within the vehicle can be carried out by closing the disconnection component by means of the control unit.

Preferentially, the step of re-establishing the low-voltage supply can be carried out before the heating step.

Thus, the vehicle is supplied with a low voltage during the increase in temperature of the storage module or modules, which makes it possible to control said increase in temperature and to ensure that it is carried out correctly.

The dewinterizing phase can be initiated by detection, by an electronic unit linked to a power supply socket of the vehicle, of a high-voltage supply signal at the level of said socket.

This electronic unit can be the control unit, controlling the position of the component for turning off the low-voltage supply. Thus, when the control unit detects a high-voltage supply signal at the terminals of the supply socket of the vehicle, it closes the component for turning off the low-voltage supply.

The method according to the invention can also comprise, before the dewinterizing phase, a step of supplying a high-voltage supply signal to the vehicle, by controlling a supply interface that is external to said vehicle, located between a supply source and said vehicle.

A supply interface can be a controllable socket located on a charging terminal, or a controllable socket supplying a charging terminal of said vehicle.

Such a supply interface can be controlled remotely, for example through a communication network of the Internet type, in a wired or wireless manner.

According to another aspect of the invention, a system is proposed for managing an electric or hybrid vehicle, with a prolonged period of non-use of said vehicle in view, said vehicle comprising at least one rechargeable electrical energy storage module, said system comprising means arranged in order to implement all the steps of the method according to the invention.

The system can in particular comprise one or more modules arranged in order to control the one or more heating means of the at least one storage module in order to stop or start said one or more heating means.

The system can also comprise:
at least one component for turning off the electrical connection, such as an electric relay, placed as close as possible to the at least one low-voltage battery of the vehicle, and arranged in order to turn off the low-voltage supply provided by said at least one voltage; and
a control unit arranged in order to:
   control the opening and closing of said component, and
   optionally, detect the presence of a supply signal at the terminals of a charging socket of said vehicle.

The system according to the invention can also comprise a controllable electrical interface, external to the vehicle and making it possible to provide to said vehicle a supply signal originating from an external source, such as the power distribution grid, for example.

According to yet another aspect of the invention, an electric or hybrid vehicle is proposed comprising:
at least one rechargeable electrical energy storage module;
at least one heating means for maintaining said at least one rechargeable electrical energy storage module at a temperature, called operating temperature, greater than ambient temperature; and
means arranged for implementing the method according to the invention.

Such a vehicle can be a private vehicle, or a shared-use vehicle of the car sharing vehicle type, or a public transport vehicle of the bus, coach or tyred tram type.

In the present application, “tyred tram” denotes an electric public transport land vehicle mounted on wheels and which is recharged at each station, so that it has no need for heavy infrastructures of the rails or catenaries type on the road system. Such an electric vehicle recharges at each station by means of charging elements of the station and a connector linking said vehicle to said station.

### DESCRIPTION OF THE FIGURES AND EMBODIMENTS

Other advantages and characteristics will become apparent from examining the detailed description of embodiments which are in no way limitative, and the attached drawings, in which:

FIG. 1 is a diagrammatic representation of a non-limitative embodiment of a method according to the invention; and

FIG. 2 is a diagrammatic representation of a non-limitative embodiment of a system according to the invention.

It is well understood that the embodiments that will be described hereinafter are in no way limitative. In particular, variants of the invention can be envisaged that comprise only a selection of the characteristics described below in isolation from the other features described, if this selection of features is sufficient to provide a technical advantage or to differentiate the invention from the state of the prior art. This selection comprises at least one, preferably functional, characteristic without structural details, or with only a part of the structural details if this part alone is sufficient to confer a technical advantage or to differentiate the invention with respect to the state of the prior art.

In the figures and in the remainder of the description, the elements common to several figures retain the same reference number.

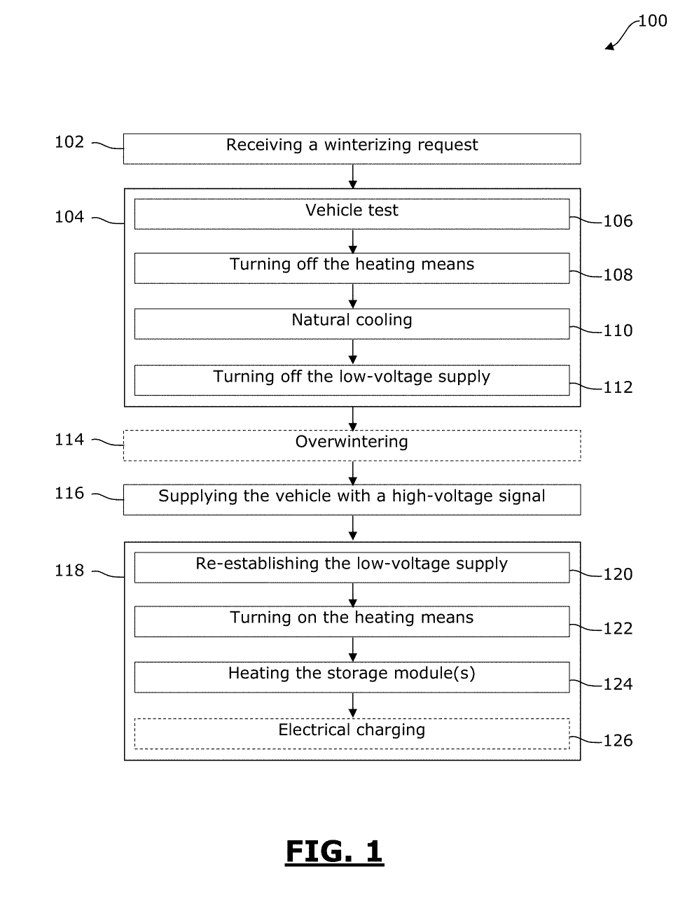

FIG. 1 is a diagrammatic representation of a non-limitative example embodiment of a method according to the invention.

The method 100, shown in FIG. 1, comprises a step 102 of receiving a winterizing request. Such a request can be transmitted by a user through a user interface within the vehicle, or using a physical interface, dedicated to transmitting such a request and manipulated using a key, for example.

Alternatively, such a request can be transmitted in an automated manner by a management box (or unit), also called BMS (Battery Management System), of an electrical energy storage module as a function of a parameter relating to said storage module. For example, when the management box detects that the storage module has a remaining charge level, also called SOC, less than or equal to 1%, it can transmit a winterizing request in order to avoid total discharge of the storage module.

Following step 102, the method 100 comprises a phase 104, called winterizing phase of the vehicle.

During this phase 104, one or more parameters relative to the vehicle are tested during a testing step 106. For example, this step 106 makes sure that:
the vehicle is stationary;
the motor of the vehicle is turned off,
etc.

If, during this step 106, there is a condition which opposes the winterizing, then phase 104 is ended or the winterizing phase does not begin.

Otherwise, a step 108 turns off the one or more heating means of the rechargeable electrical energy storage module or modules of the vehicle.

Then, during a step 110 the storage modules are left to cool naturally, until reaching ambient temperature or a predetermined temperature. During this step the change in temperature of each storage module is monitored, for example by the BMS box.

When all the storage modules of the vehicle have reached the desired temperature, then a step 112 stops the low-voltage supply to the components of the vehicle. In particular, this step 112 initiates the opening of a disconnection component, such as a relay, for turning off the low-voltage supply of the vehicle from one or more low-voltage batteries. The opening of said relay can be controlled by a control unit (or box).

Of course, this control unit is supplied at all times by a dedicated battery or by the low-voltage battery or batteries.

At any time, during the winterizing phase 104, supplying the vehicle with a high-voltage signal ends said winterizing phase 104.

To this end a module, for example the control unit, can monitor the charging socket of the vehicle. When the control unit detects the presence of a high-voltage signal at the terminals of the charging socket of the vehicle, it then ends the winterizing phase 104 by transmitting a request to the storage modules or to a management module of said vehicle.

It is important to note that detecting the presence of a plug in the charging socket of the vehicle, or detecting a mechanical connection of the vehicle to a charging terminal, without detecting the presence of a high-voltage signal does not end the winterizing phase.

At the end of step 112 the vehicle is in a winterizing configuration in which the electrical energy losses are reduced as far as possible:
on the one hand at the level of each electrical energy storage module supplying the high-voltage supply signal of the electric motor of the vehicle; and
on the other hand at the level of the low-voltage battery or batteries supplying the vehicle with a low voltage.

In the winterizing configuration as described in the present example, only the control unit of the relay of the low-voltage supply of the vehicle remains supplied. All the other components of the vehicle are de-energized.

At any moment during the overwintering phase, it is possible to end the overwintering of the vehicle by a step 116 of supplying a high-voltage to the vehicle by a source external to the vehicle.

The supply step 116 can be carried out by connecting the vehicle, in particular manually, to a charging terminal supplied by an external source, such as for example the power distribution grid.

The supply step 116 can also be carried out by initiating, locally or remotely, in a wired or wireless manner, the supply of a charging terminal or a charging interface, to which the vehicle is already connected.

According to a preferred example embodiment, the vehicle can be connected, directly or indirectly, to a power socket that can be controlled remotely, and this may be during the overwintering 114 and optionally during the winterizing phase 104. This socket is not supplied during the winterizing 104 and overwintering 114 phases. During the step 116, the controllable socket can be controlled, for example through a communication network of the Internet type, in order to allow the high-voltage signal to pass to the vehicle. Thus, a user can end the overwintering phase 114 remotely.

The step 116 of initiating the high-voltage supply of the vehicle is followed by a phase 118, called dewinterizing phase.

During this phase 118, a step 120 re-establishes the low-voltage supply within the vehicle. This step 120 can for example be carried out by the control unit which monitors the presence or absence of a high-voltage signal at the level of the charging socket of the vehicle. As soon as the control unit detects the presence of the high-voltage signal, it closes the low-voltage supply relay of the vehicle.

At this moment, all the low-voltage components of the vehicle are supplied.

Then, during a step 122 the one or more heating means of each storage module is (are) turned on in order to heat each module with a heating signal provided by the external source via the interface or a charging terminal or even a wall-mounted box of the “Wall Box” type.

During a step 124, each storage module is heated until reaching a predetermined operating temperature. In the case of LMP® storage modules, the operating temperature is of the order of 70° C., and the heating step 124 can last approximately 4 hours.

When each storage module has reached the predetermined operating temperature, then the dewinterizing phase 118 can comprise an optional step 126 of electrical charging of at least one storage module.

After the dewinterizing phase 118, the vehicle is ready for use.

In the example described, a user remote from the vehicle can initiate the dewinterizing phase 118, and find his vehicle ready for use on his arrival.

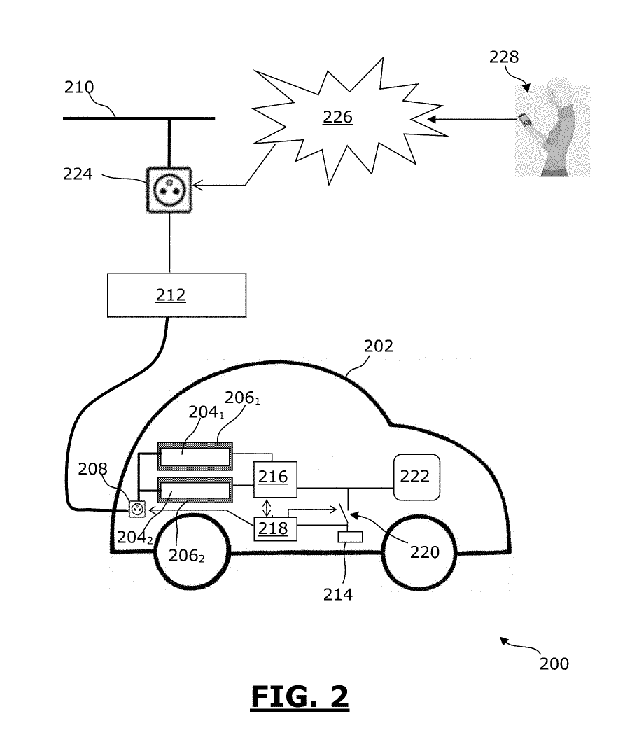

FIG. 2 is a diagrammatic representation of a non-limitative example embodiment of a system for implementing the method according to the invention, and in particular the method 100 in FIG. 1.

The system 200, represented in FIG. 2, is implemented for managing an electric vehicle 202 comprising two rechargeable electrical energy storage modules 204₁ and 204₂. Each storage module 204₁-204₂ is associated with a heating means, respectively 206₁ and 206₂, in order to heat and maintain said storage module at an operating temperature greater than ambient temperature, such as for example 70° C.

Each heating means 206 has the form of a heating plate, for example.

The vehicle is equipped with a charging socket 208 for receiving a high-voltage heating signal and a high-voltage charging signal provided by an external source, such as the power distribution grid 210, optionally via a charging device, such as a wall box 212.

The vehicle 202 also comprises a low-voltage battery 214 supplying the different components of the vehicle 202 with a low voltage, for example 12V.

The system 200, represented in FIG. 2, comprises one or more electronic boxes 216 configured in order to:
control, directly or indirectly, the heating means 206 of the storage modules 204; and
monitor, directly or indirectly, the temperature and the charge level of each storage module 204.

The system 200 also comprises an electronic unit 218, called control unit, supplied by the low-voltage battery 214 at all times. This control unit 218 is configured in order to monitor the presence or absence of a high-voltage signal at the level of the charging socket 208.

The system 200 also comprises a component for disconnecting an electrical connection, such as a relay 220, arranged downstream of the low-voltage battery 214, and in immediate proximity to said battery 214, and making it possible to turn off the low-voltage supply to all of the components of the vehicle, except the control box 218.

The control unit 218 is configured in order to control the relay 220 either to an open state or a closed state. In particular, the control unit 218 is configured in order to control the relay 220:
to an open position when the temperature of the storage modules 204 reaches ambient temperature or a predetermined temperature, during an entering the winterizing phase; and
to a closed position when a high-voltage signal is detected at the level of the charging socket 208, in order to initiate a dewinterizing phase.

In addition, during an entering the winterizing phase, the control unit 218 is also configured in order to end an entering the winterizing phase as soon as a high-voltage signal is detected at the level of the charging socket 208.

The vehicle 202 comprises a user interface 222, for example in the form of a touch screen, in order to send a winterizing order. Alternatively, the winterizing order can be sent through a physical interface manipulated by a key, for example.

The system 200 also comprises a socket 224 that can be controlled remotely though a wireless or wired communication network 226 of the Internet type.

Thus, a user 228 can control the socket 224 in order to supply the vehicle 202 with a high-voltage signal in order to initiate, remotely, the dewinterizing phase of the vehicle 202. Controlling the socket 224 can be carried out through a user device of the computer or smartphone type.

The low-voltage battery can be a 12V, 24V or 48V battery.

Alternatively to that which is described, the vehicle may not be equipped with a socket but with a cable equipped with a power plug provided in order to plug into a socket provided on a charging terminal or a wall box, for example.

Of course, the invention is not limited to the examples detailed above. For example, the vehicle can comprise a different number of storage modules.

1. A method for managing an electric or hybrid vehicle comprising at least one rechargeable electrical energy storage module, each storage module comprising one or more Lithium-Metal-Polymer batteries and being arranged in order to:
provide a high-voltage electrical supply signal for driving said vehicle; and
be maintained at a temperature, called operating temperature, by a heating means;
said method comprising:
before a prolonged period of non-use of said vehicle, a phase, called winterizing phase, comprising a step of cooling each storage module in order to reach a predetermined temperature, lower than said operating temperature; and
following a prolonged period of non-use of said vehicle, a phase, called dewinterizing phase, comprising a step of heating each storage module in order to reach an operating temperature comprised between 60° C. and 80° C.

2. The method according to claim 1, characterized in that the step of cooling a storage module comprises:
turning off the means of heating said module; and
natural cooling of said storage module.

3. The method according to claim 1, characterized in that the vehicle comprises at least one low-voltage battery, supplying at least one low-voltage circuit within said vehicle, the winterizing phase also comprising a step of turning off the low-voltage supply provided by said at least one low-voltage battery.

4. The method according to claim 3, characterized in that the step of turning off the low-voltage supply is carried out after the cooling step.

5. The method according to claim 1, characterized in that the winterizing phase is initiated following a request from a user.

6. The method according to claim 1, characterized in that the winterizing phase is initiated automatically when a predetermined parameter, relating to a storage module reaches a predetermined threshold value, in particular when the State of Charge (SOC) reaches a value less than or equal to 1%.

7. The method according to claim 1, characterized in that it comprises stopping and cancelling the winterizing phase following a detection, during said winterizing phase, of a high-voltage supply signal of said vehicle provided by an external source.

8. The method according to claim 3, characterized in that the dewinterizing phase comprises a step of re-establishing the low-voltage supply by the at least one low-voltage battery.

9. The method according to claim 8, characterized in that the step of re-establishing the low-voltage supply is carried out before the heating step.

10. The method according to claim 1, characterized in that the dewinterizing phase is initiated by a detection, by an electronic unit linked to a supply socket of the vehicle, of the presence of a high-voltage supply signal at the level of said socket.

11. The method according to claim 1, characterized in that it comprises, before the dewinterizing phase, a step of providing a high-voltage supply signal to the vehicle, by controlling a supply interface external to said vehicle, located between a supply source and said vehicle.

12. The method according to claim 11, characterized in that the supply interface is controlled remotely, through a wired or wireless communication network.

13. A system for managing an electric or hybrid vehicle with a prolonged period of non-use of said vehicle in view, said vehicle comprising at least one rechargeable electrical energy storage module said system comprising means arranged in order to implement all the steps of the method according to claim 1.

14. An electric or hybrid vehicle comprising:
at least one rechargeable electrical energy storage module;
at least one heating means for maintaining said at least one rechargeable electrical energy storage module at a temperature, called operating temperature, greater than ambient temperature; and
means arranged in order to implement the method according to claim 1.
